(19) United States
(12) Patent Application Publication
(10) Pub. No.: US 2026/0328621 A1
(43) Pub. Date: Oct. 22, 2026

(54) DEVICE FOR ANALYSIS OF OPTICAL SPECTRUM AND METHOD FOR ANALYSIS OF OPTICAL SPECTRUM

(71) Applicant: PHOTONPATH S.R.L, Milano (IT)

(72) Inventors: Douglas OLIVEIRA MORAIS DE AGUIAR, MILANO (IT); Emanuele GUGLIELMI, MILANO (IT); Alessandro PERINO, MILANO (IT); Elena DAMIANI, MILANO (IT); Mattia Thomas CONTI, MILANO (IT); Ilaria DILUCH, MILANO (IT); Fabio TOSO, MILANO (IT); Piero BORGA, MILANO (IT)

(21) Appl. No.: 19/113,107

(22) PCT Filed: Sep. 14, 2023
(86) PCT No.: PCT/IT2023/050210

§ 371 Date: Mar. 19, 2025

(30) Foreign Application Priority Data
Sep. 19, 2022 (IT) 102022000019191

(51) Int. Cl. G01J 3/45; G01J 3/02

(52) U.S. Cl. CPC G01J 3/45; G01J 3/0224; G01J 3/0227

(57) ABSTRACT

Device (1) for analysis of optical spectrum of an optical signal, and method for analysis of optical spectrum which exploits said device, wherein the device (1) comprises an optical filter stage (2), having an optical path (5); a photodetector (17) optically connected downstream of the optical filter stage (2); an actuator (18) configured to vary an optical refractive index of at least one section of the optical path (5); wherein the optical filter stage (2) comprises a first Mach-Zehnder interferometer (6) and a first ring resonator (7) connected in cascade to each other to form respective portions of the optical path (5), wherein a difference in respective optical path (dLo) between a first (11) and a second optical branch (12) of the first Mach-Zehnder interferometer (6) is greater than zero, and wherein the first Mach-Zehnder interferometer (6) is optically connected to a remaining portion of the optical path (5) by means of one and only one first port (13) of an input optical coupler (9) and by means of one and only one second port (14) of an output optical coupler (10).

### TECHNICAL FIELD OF THE INVENTION

The present invention relates to a device for analysis of optical spectrum and to a method for analysis of optical spectrum.

### STATE OF THE ART

The present invention belongs to the field of photonics, i.e. the set of the technologies and the methods for the generation, and/or the transmission, and/or the processing and/or the reception of optical signal.

The term “optical” refers to an electromagnetic radiation not necessarily falling strictly within the visible optical band (i.e. indicatively 400-700 nm), but more generally falling in a band wider than the visible optical band, for example including the near infrared (e.g. wavelength between about 700 nm and about 2 μm).

In the field of photonics, devices for analysis of optical spectrum (also called OSA, from the English “optical spectrum analyzer”) are known, used to analyse the optical spectrum of an optical signal. The expression “optical spectrum” typically refers to the power distribution (e.g. expressed in dBm or Watt) of the optical signal as a function of the wavelength or frequency.

Document US 2017/0331550 A1 discloses an OSA comprising a modulator, an integrated optical filter and a photodetector.

### SUMMARY OF THE INVENTION

In the context of the aforementioned devices for analysis of optical spectrum, the Applicant has made the following considerations (hereinafter, where reference is made to the wavelength of the optical signal, similar considerations also apply in terms of frequency).

First of all, the Applicant considers it particularly advantageous to be able to determine the optical spectrum of an optical signal with high resolution, i.e. to be able to determine an optical intensity of a plurality of optical sub-signals each comprising a respective sub-range of wavelengths, such as each sub-range of wavelengths is as narrow as possible (and the sum of the sub-ranges analyzed fully includes the wavelength range of the optical signal of origin). This allows to obtain an optical spectrum having a desired precision and which is as faithful as possible to the effective distribution of optical intensity per unit wavelength of the optical signal of origin.

To this end, it is advantageous to produce a device for analysis of optical spectrum comprising at least one optical filter stage of the input optical signal capable of filtering the optical signal to allow the transmission (e.g. towards a photodetector downstream of the optical filter stage) of only a portion of the optical signal corresponding to a sub-range of wavelengths as narrow as possible. This translates into the realization of a device whose optical filter stage is characterized by an overall transfer function (e.g. obtained from the product of the individual transfer functions of the optical filter components that realize the filter stage) comprising the periodic repetition of a (single) peak of desired amplitude (e.g. mid-height amplitude, also known as FWHM): the smaller the amplitude, the higher the achievable resolution.

The range of wavelengths subtended by the aforesaid peak is known as passband.

Furthermore, since, as described above, the peak of the overall transfer function is periodically repeated, it follows that, if two (or more) repetitions of the aforementioned peak lies simultaneously within the band of the optical signal (i.e. the range of wavelengths included by the optical signal), a disturbance in the detected optical intensity would be obtained, since this intensity would not unequivocally correspond to a single well-established passband, but to two (or more). This would consequently lead to problems in determining the final optical spectrum actually corresponding to the optical signal.

The Applicant has therefore also found that it is particularly advantageous obtaining the overall transfer function of the optical filter stage in such a way that the distance between two consecutive repetitions of the aforementioned peak (known as free spectral distance, also called FSR) is wide (wider than the overall band of the signal).

The Applicant, on the basis of the aforesaid considerations, has found that the devices known in the aforesaid context run into various problems, and can therefore be improved under one or more aspects.

For example, in fact, the integrated optical filter of the device described in US 2017/0331550 A1, which comprises two ring resonators arranged in cascade, is affected by practical manufacturing problems, in particular related to the level of construction quality (for example very small manufacturing tolerances) that the ring resonators must meet in order to achieve a desired (high) resolution and a wide free spectral distance. For example, a parameter that characterizes a ring resonator is the quality factor of the ring, also called Q-factor, which represents the ratio between the free spectral range and the passband of the transfer function of the ring resonator. In other words, a ring with a very high Q-factor (typically of the order of 10⁴, 10⁵ or even higher) is typically an indication of a ring resonator with reduced passband and wide free spectral range.

However, ring resonators with such high Q-factors are not easy to produce and/or find on the market, as well as being highly sensitive to manufacturing defects, which makes these elements highly delicate.

The Applicant has therefore faced the problem of realizing a device for analysis of optical spectrum having the desired operational properties (e.g. in terms of resolution and free spectral range), and which is at the same time robust and/or structurally simple and/or easy to manufacture and/or to operate.

According to the Applicant, the above problem is solved by a device for analysis of optical spectrum according to the attached claims and/or having one or more of the following features.

According to an aspect, the invention relates to a device for analysis of optical spectrum of an optical signal.

The device comprises:
an optical filter stage, having an input port, an output port and an optical path which develops from said input port to said output port;
a photodetector, optically connected to said optical filter stage downstream of said output port;
an actuator, coupled to said optical filter stage and configured to vary an optical refractive index of at least one section of said optical path of said optical filter stage;

wherein said optical filter stage comprises a first Mach-Zehnder interferometer (MZI) and a first ring resonator connected to each other in cascade to form respective portions of said optical path,

wherein said first Mach-Zehnder interferometer comprises an input optical coupler, an output optical coupler and a first and a second optical branch which connect said input optical coupler to said output optical coupler,

wherein a difference of respective optical path between said first and second optical branch of said first Mach-Zehnder interferometer is greater than zero,

and wherein said first Mach-Zehnder interferometer is optically connected to a remaining portion of said optical path of the optical filter stage by means of one and only one first port of the input optical coupler and by means of one and only one second port of the output optical coupler.

According to the Applicant, the optical filter stage, comprising an unbalanced Mach-Zehnder interferometer (i.e. with one optical branch having a greater length than the other) and a ring resonator, allows to combine the transfer functions of such optical components in a particularly advantageous and synergistic way, allowing to obtain an overall transfer function of the optical filter stage having the desired properties in terms of resolution and free spectral range (i.e. high resolution and wide free spectral range).

On the one hand, in fact, by the unbalanced MZI it is possible to have a transfer function characterized by a single peak periodically repeated with desired free spectral range (e.g. high FSR compared to the typical bands of the optical signals analyzed by such devices, such as for example the optical signals used in the telecommunications). On the other hand, the ring resonator allows to provide a respective transfer function having a peak (also periodically repeated) characterized by a narrow amplitude (i.e. a very thin peak).

In this way, by combining the transfer functions corresponding to the two aforementioned optical components, it is obtained an overall transfer function (which represents the product of the individual transfer functions) having the combination of the advantages of the individual transfer functions and capable of compensating, mitigating each other, their respective disadvantages, thus obtaining an overall transfer function with wide free spectral range and peaks having small amplitude (i.e. high resolution), obtaining at the same time numerous practical advantages in terms of robustness and ease of implementation and/or operation of the optical filter stage.

In fact, not only the MZI by itself is a robust optical component and less sensitive to manufacturing tolerances than a ring resonator, but its presence synergistically allows to greatly relax the constructive constraints of the ring resonator, which therefore must not necessarily have both high resolution and wide free spectral range (i.e. necessarily a high Q-factor), but it is sufficient that it has (only) the desired resolution (i.e. reduced amplitude of the peaks, independently of their mutual distance), to the full advantage of greater sturdiness and simplicity of manufacturing and/or finding and/or using the ring resonator (since resonators having (only) this characteristic are simpler to make in practice), as well as of the optical filter stage thus obtained.

Furthermore, the fact that the Mach-Zehnder interferometer is optically connected to a remaining portion of the optical path of the optical filter stage by one and only one first port of the input optical coupler and by one and only one second port of the output optical coupler (typically a port in cross configuration with respect to the used first port of the input optical coupler), allows to obtain at the photodetector a signal intensity already directly representative of the optical intensity of the optical signal in the pass band, thus limiting subsequent reprocessing phases (e.g. software) of the signal of the photodetector, such as Fourier Transform Spectroscopy (FTS) operations, simplifying the functioning and/or decreasing the computational effort of the device.

Finally, the presence of the actuator, coupled to the optical filter stage and configured to vary an optical refractive index of at least one section of the optical path of the optical filter stage, allows to dynamically vary the passband of the overall transfer function of the optical filter stage, in such a way as to be able to scan the whole range of wavelengths of the optical signal and thus analyze the complete spectrum of the optical signal.

By “photodetector” it is meant an optoelectronic component structured for transducing a respective optical input signal into an electrical signal (current and/or voltage) representative of an optical intensity of the respective optical input signal.

The terms “upstream”, “downstream”, “interposed”, “input”, “output”, “cascade” refer to the direction of propagation of the considered optical signal. The term “directly”, in combination with “upstream”, “downstream” etc., implies the absence of further interposed elements (except the connecting optical waveguide).

By “optical coupler” it is meant an optical component capable of distributing an optical power entering a first port between a pair of second output ports. For example, an optical coupler comprises a pair of first ports, a pair of second ports and a pair of optical branches (e.g. semiconductor optical waveguides) each connecting a respective first port to a respective second port, wherein the two optical branches are mutually optically coupled at a respective optical coupling tract interposed between the respective first port and the respective second port. Examples of optical couplers are tunable directional optical couplers (also called TDCs, from the English “tunable directional coupler”), power dividers, MMIs (Multi mode interferometers), Y-branches interferometers, Star couplers, MZIs.

The present invention, in the above aspect, may have one or more of the following preferred features.

Preferably said optical filter stage comprises one or more second Mach-Zehnder interferometers (distinct from said first Mach-Zehnder interferometer) connected to each other in cascade to each form a respective portion of said optical path. Preferably each second Mach-Zehnder interferometer comprises a respective input optical coupler, a respective output optical coupler and a respective first and second optical branch which connect said respective input optical coupler to said respective output optical coupler, where a difference in respective optical path between said respective first and second optical branch is greater than zero. Preferably said differences in respective optical path of said first Mach-Zehnder interferometer and of said one or more second Mach-Zehnder interferometers are all different from each other. In this way it is possible to suitably combine the transfer functions of each unbalanced MZI to further improve the characteristics (e.g. in terms of resolution and/or FSR) of the overall transfer function of the optical filter stage.

Preferably each second Mach-Zehnder interferometer is optically connected to a respective remaining portion of said optical path of the optical filter stage by means of one and only one respective first port of the respective input optical coupler and by means of one and only one respective second port of the respective output optical coupler. In this way, the introduction of further MZIs does not disturb the analysis of the optical spectrum in terms of direct relationship between the measured optical intensity and the effective optical intensity of the filtered optical signal portion.

Preferably said one and only one second port of the output optical coupler of each Mach-Zehnder interferometer is arranged in cross configuration with respect to said one and only one first port of the input optical coupler of the respective Mach-Zehnder interferometer. By cross configuration (or “cross port”) it is meant that said one and only one second port belongs to an optical branch of the Mach-Zehnder interferometer different from the optical branch to which said one and only one first port belongs (vice versa for the “bar door”). In this way, robust operation of the respective MZI is achieved, even against possible construction defects, as it is, for example, possible to achieve a desired spectral isolation (i.e. a transfer function of the MZI which nulls outside the respective bandwidth). In this way a desired overall transfer function of the optical filter stage is obtained.

Preferably said one or more second Mach-Zehnder interferometers comprise two, and/or no more than nineteen, more preferably no more than nine, even more preferably no more than two, second Mach-Zehnder interferometers. In this way the complexity of the device and/or the number of components are limited. The Applicant has also realized that the presence of (at least) one ring resonator along the optical path synergistically limits the overall number of unbalanced MZIs to be arranged in cascade in the optical filter stage, for a given obtainable resolution and free spectral range.

Preferably said first ring resonator is a single ring resonator of said optical filter stage. Thus the device is structurally simple.

In one embodiment said optical filter stage comprises one or more second ring resonators (distinct from said first ring resonator) connected to each other in cascade to each form a respective portion of said optical path. Preferably a respective micro-ring of said first ring resonator and of each second ring resonator all have different radii. In this way the overall transfer function of the optical filter stage in terms of resolution and/or free spectral range is further improved.

In one embodiment said one or more second ring resonators comprise two, and/or no more than seven, more preferably no more than four, second ring resonators. In this way the structural complexity of the device is limited. Typically, each ring resonator comprises at least one micro-ring (in embodiments a series of cascaded micro-rings) interposed and optically coupled to two optical waveguides, a respective input port and a respective drop port arranged on a different optical waveguide with respect to the input port (also known as “drop” port). Preferably each ring resonator is optically connected to a respective remaining portion of said optical path (and possibly of the further optical path described below) by only the respective input port and by only the respective drop port. In this way the resonators are suitably arranged to contribute to the overall transfer function of the filter stage.

Preferably said difference in optical path between said first and second optical branch of said first Mach-Zehnder interferometer is function of a band of the optical signal. Preferably said difference in optical path is such that a transfer function of said first Mach-Zehnder interferometer has a free spectral range (FSR) substantially equal to, or greater than, a width of said band of the optical signal. In this way the whole band of the optical signal is analysed. Preferably said respective difference in optical path of each second Mach-Zehnder interferometer is function of the difference in optical path of said first Mach-Zehnder interferometer, more preferably it is equal to 2ⁱ times said difference in optical path of the first Mach-Zehnder interferometer, with i equal to an order of the respective second Mach-Zehnder interferometer. In this way the respective transfer function of the i-th second MZI results provided with a free spectral range equal to half of the free spectral range of the transfer function of the Mach-Zehnder interferometer with index i-1 (for i=1, the free spectral range is half of the free spectral range of the first MZI, which can be assumed corresponding to i=0). In this way, it is obtained in an advantageously simple way a condition whereby the maxima of all the peaks, except one, of the transfer function of the i-th MZI are positioned, on the wavelength axis, at a valley of the transfer function of the MZI with index i-1. In this way all the peaks, except one, suppress each other, realizing in a constructively simple way an overall transfer function having only one peak (corresponding to the coincident maximum point of all the transfer functions of the individual MZIs). This makes it possible to optimize the use of the MZIs since, for given final properties of the overall transfer function, the number of MZIs used is limited.

Preferably said difference in optical path of the first Mach-Zehnder interferometer is greater than or equal to 1 μm. In this way the FSR is comparable with the typical band of the optical signal used in the field of telecommunications (e.g. about 1520-1580 nm).

Preferably said difference in optical path of the first Mach-Zehnder interferometer (and possibly of each second Mach-Zehnder interferometer) is less than or equal to 2 mm. In this way the spatial extension of the optical filter stage is limited, to the advantage of the overall dimensions of the device (e.g. for the specific use on supports of limited dimensions, such as for example integrated chips).

Preferably a radius of a micro-ring of said first ring resonator is function of said difference in optical path of the first Mach-Zehnder interferometer, more preferably a circumference of said micro-ring of the first ring resonator is equal to 2ⁿ⁺¹ times said difference in optical path of the first Mach-Zehnder interferometer, with n equal to a total number of second Mach-Zehnder interferometers. In one embodiment a respective circumference of a micro-ring of each second ring resonator is equal to 2^{n+1+m} times said difference in optical path of the first Mach-Zehnder interferometer, with m equal to the order of the second ring resonator. In this way the same considerations described above with reference to the halving of the free spectral ranges of the MZI are valid, as well as analogous advantages are obtained in terms of optimization of the use of the ring resonators.

Preferably said one or more second Mach-Zehnder interferometers are arranged in continuous succession with said first Mach-Zehnder interferometer (i.e., whatever the total number of MZIs used, they are all arranged directly downstream of the previous one, without interruptions). Preferably said one or more second ring resonators are arranged in continuous succession with said first ring resonator. This simplifies the structure of the device.

Preferably said input port of the optical filter stage coincides with said one and only one first port of the input optical coupler of the first Mach-Zehnder interferometer, and said output port of the optical filter stage coincides with the drop port of said first ring resonator (or of a last second ring resonator of said continuous succession of ring resonators). Preferably said photodetector is directly optically connected to said output port of the optical filter stage. In this way the device is simplified.

Preferably said device comprises a pre-treatment stage of said optical signal upstream of said optical filter stage (and of said possible further optical filter stage). Preferably said pre-treatment stage comprises a polarization separator for separating a first polarization component (e.g. electric transverse polarization component) from a second polarization component (e.g. magnetic transverse) of the optical signal.

Preferably said pre-treatment stage comprises a respective input port and a respective first and a respective second output port (each for the first and the second polarization component respectively).

Preferably said pre-treatment stage comprises a polarization rotator for rotating a polarization of said second polarization component of the optical signal (e.g. by 90°). The rotation of one of the polarization components (typically the transverse magnetic one) allows imparting to the second polarization component the same polarization as the first polarization component, while however preserving its respective optical intensity. In this way it is also possible to analyze the second polarization component by means of the same device for analysis, without having to exploit, in use, suitable modifications and/or calibrations and/or adaptations. In this way the device is widely versatile and capable of analyzing the optical spectrum of the optical signal independently of its polarization (typically variable over time).

In a first embodiment said device comprises a further optical coupler (distinct from the Mach-Zehnder interferometers) interposed between said pre-treatment stage and said optical filter stage, wherein each of said first and second output ports of the pre-treatment stage is (directly) optically connected to one (and only one) respective first port of said further optical coupler, and wherein one and only one second port of said further optical coupler is (directly) optically connected to said input port of the optical filter stage (preferably directly optically connected to said one and only one first port of the input optical coupler of the first Mach-Zehnder interferometer). Preferably said device further comprises a first and a second optical switch (e.g. a variable optical attenuator or VOA) respectively interposed between said respective first and second output ports of the pre-treatment stage and the corresponding first port of the further optical coupler. In this way, it is created in a simple and effective way a structure capable of selectively passing towards the optical filter stage only one or the other polarization component (electric or magnetic) of the optical input signal, in order to analyze the corresponding optical spectrum thereof.

Preferably said continuous succession of Mach-Zehnder interferometers is arranged directly upstream of said continuous succession of ring resonators. In this way the overall structure of the device is simplified.

In a second embodiment said optical filter stage comprises a first 3 dB optical coupler (distinct from the Mach-Zehnder interferometers) to form a respective portion of said optical path and interposed between said first Mach-Zehnder interferometer (or, if present, said one or more second Mach-Zehnder interferometers) and said first ring resonator. Preferably one (and only one) first port of said first 3 dB optical coupler is (directly) optically connected to said one and only one second port of said output optical coupler of said first Mach-Zehnder interferometer (or of a respective output optical coupler of a second Mach-Zehnder interferometer arranged in last position along the respective sequence). Preferably one (and only one) second port of the first 3 dB optical coupler is (directly) optically connected to said input port of the first ring resonator. Preferably a remaining second port of the first 3 dB optical coupler is (directly) optically connected to said second output port of said pre-treatment stage.

Preferably said device comprises a further optical filter stage comprising a further input port, a further output port and a further optical path which develops from said further input port to said further output port. Preferably said further optical filter stage comprises said first Mach-Zehnder interferometer (and more preferably each second Mach-Zehnder interferometer) in common with the optical filter stage and a further ring resonator (distinct from the first ring resonator and from the one or more second ring resonators) connected to each other in cascade to form respective portions of said further optical path. In this way an optical filter stage is created for each polarization component of the optical signal (which in operation propagate along opposite directions), while keeping the device compact since the first MZI (and possibly each second MZI) is in common. The combination of the first MZI and the further ring resonator allows to obtain an overall transfer function of the further optical filter stage having the same advantages described above in relation to the optical filter stage.

In one embodiment said further optical filter stage comprises a plurality of further ring resonators (comprising said further ring resonator). Preferably said further ring resonator (or possibly said plurality of further ring resonators) comprises one or more, more preferably all, the features of said first ring resonator (and possibly of said one or more second ring resonators), where appropriate referred to said further optical filter stage. In this way a desired overall transfer function is obtained.

Preferably said device comprises a further photodetector optically connected to said further optical filter stage downstream of said further output port, more preferably to a drop port of said further ring resonator.

Preferably said further optical filter stage comprises a second 3 dB optical coupler (distinct from the Mach-Zehnder interferometers and from the first 3 dB optical coupler) to form a respective portion of said further optical path and interposed between said first Mach-Zehnder interferometer and said further ring resonator. Preferably one (and only one) first port of the second 3 dB optical coupler is (directly) optically connected to said first output port of said pre-treatment stage. Preferably a remaining first port of the second 3 dB optical coupler is (directly) optically connected to an input port of said further ring resonator. Preferably one (and only one) second port of the second 3 dB optical coupler is (directly) optically connected to said one and only one first port of said input optical coupler of said first Mach-Zehnder interferometer.

The aforementioned features of optical connection of the first and second 3 dB optical coupler allow, in a structurally simple way and/or with a limited number of components, to create a closed-loop device architecture such that the first polarization component is addressed to the optical filter stage and the second polarization component is simultaneously addressed to the further optical filter stage with opposite propagation direction. The Applicant has found that, despite the simultaneous presence of both the polarization components along the common section of the optical path and of the further optical path created by the Mach-Zehnder interferometer/s, they do not interfere with each other, allowing to simultaneously obtain both their respective optical spectra. In this way the device is versatile and functional and with a short spectral scanning cycle.

Preferably a radius of each micro-ring of said first ring resonator (and optionally of each second and further ring resonator) is less than or equal to 500 μm. In this way the dimensions of the device are contained.

In said second embodiment, preferably said device comprises an optical isolator arranged upstream of said pre-treatment stage. In this way the unwanted signal residues due to the closed-loop architecture are suppressed.

Preferably said actuator is also coupled to said further optical filter stage and configured to vary an optical refractive index of at least one section of said further optical path of said further optical filter stage.

Preferably said actuator comprises a plurality of sub-actuators, each sub-actuator being coupled to a respective Mach-Zehnder interferometer or to a respective ring resonator (for varying an optical refractive index of a tract of a respective optical path).

According to another aspect, the invention relates to a method for analysis of optical spectrum of an optical signal having a band. The method comprises:
providing a device for analysis according to the present invention in any embodiment;
introducing said optical signal as input to said device;
tuning, by means of said actuator, said optical filter stage (and possibly the further optical filter stage) to move (in continuous) a passband of said optical filter stage (and possibly of the further optical filter stage) along said band of the optical signal;
for each passband, acquiring by means of said photodetector (and possibly also by means of said further photodetector) a respective signal representative of an optical intensity of said optical signal in said passband;
calculating said optical spectrum as a function of said respective signals representative of the optical intensity. In this way the optical spectrum is obtained with the desired resolution and with structural simplicity.

Preferably said method further comprises a deconvolution routine of said respective signals representative of the optical intensity. Preferably said deconvolution routine comprises:
determining an overall transfer function of said optical filter stage (and possibly of said further optical filter stage);
calculating a Fourier transform (e.g. by means of FFT algorithms) of said overall transfer function of the optical filter stage (and of the further optical filter stage);
calculating a Fourier transform (e.g. by means of FFT algorithms) of said respective signals representative of the optical intensity in said band;
for each passband, calculating a quotient between said Fourier transform of said respective signals representative of the optical intensity and said Fourier transform of said overall transfer function of the optical filter stage (and of the further optical filter stage);
calculating an anti-Fourier transform (e.g. using FFT algorithms) of said quotient.

In this way a desired resolution of the optical spectrum is obtained.

### BRIEF DESCRIPTION OF THE DRAWINGS

FIG. 1 shows a block diagram of a first embodiment of the device according to the present invention;

FIG. 2 schematically shows a circuit form of the device of FIG. 1;

FIG. 3 shows a block diagram of a second embodiment of the device according to the present invention;

FIG. 4 schematically shows a circuit form of the device of FIG. 3;

FIG. 5 graphically shows an example of transfer functions of the optical components of the optical filter stage;

FIG. 6 graphically shows an example of overall transfer function obtainable from the transfer functions of FIG. 5;

FIGS. 7-10 graphically show the results of some simulations of the method for analysis according to the present invention.

### DETAILED DESCRIPTION OF SOME EMBODIMENTS OF THE INVENTION

The features and the advantages of the present invention will be further clarified by the following detailed description of some embodiments, presented by way of non-limiting example of the present invention, with reference to the attached figures (not to scale).

Number 1 in the figures indicates a device for analysis of optical spectrum of an optical signal.

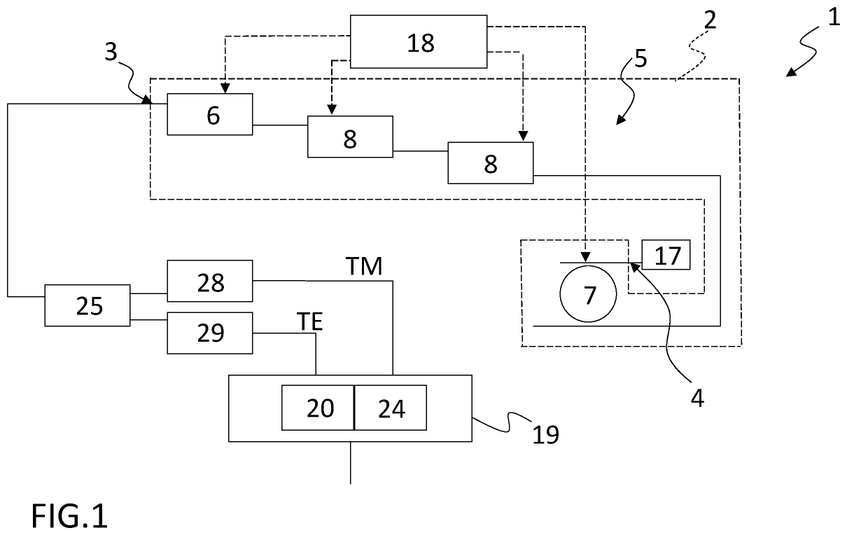

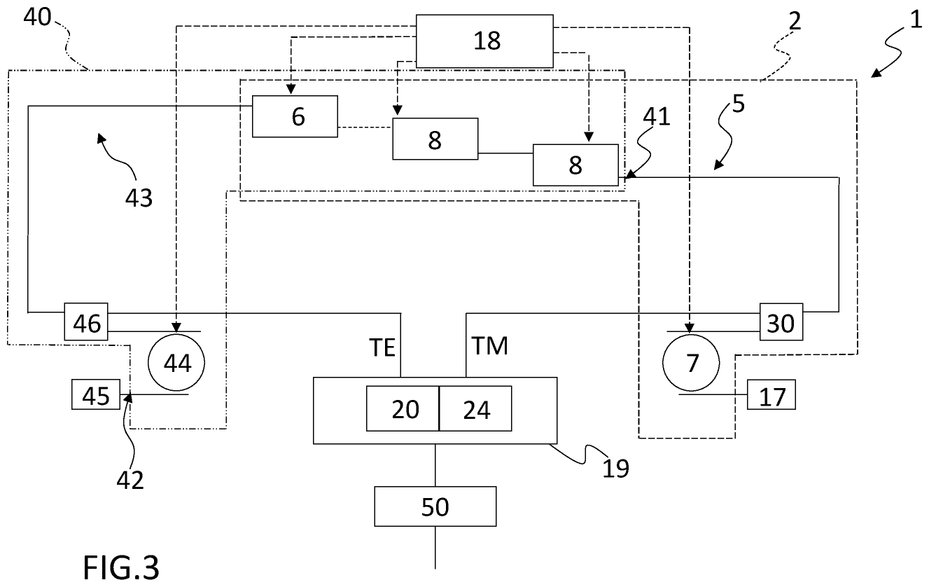

The device 1 comprises an optical filter stage 2 (closed dotted line shown in FIGS. 1 and 3), having an input port 3, an output port 4 and an optical path 5 which develops from the input port to the output port.

The optical filter stage 2 comprises a first Mach-Zehnder interferometer 6 and a first ring resonator 7 connected to each other in cascade to form respective portions of the optical path 5.

Exemplarily, the optical filter stage 2 further comprises two second Mach-Zehnder interferometers 8 connected to each other in cascade to each form a respective portion of the optical path (for a total of three Mach-Zehnder interferometers). Exemplarily the two second Mach-Zehnder interferometers 8 are arranged in continuous succession with the first Mach-Zehnder interferometer 6 (i.e. one directly downstream of the previous one).

The first Mach-Zehnder interferometer 6, and exemplarily each second Mach-Zehnder interferometer 8, comprises a respective input optical coupler 9, 9′, a respective output optical coupler 10, 10′ and a respective first 11, 11′ and second optical branch 12, 12′ which connect the respective input optical coupler 9 to the respective output optical coupler 10.

The first Mach-Zehnder interferometer 6, and exemplarily each second Mach-Zehnder interferometer 8, is optically connected to a respective remaining portion of the optical path 5 of the optical filter stage by means of one and only one first port 13, 13′ of the respective input optical coupler 9, 9′ and by means of one and only one second port 14, 14′ of the respective output optical coupler 10, 10′.

Exemplarily the one and only one second port 14, 14′ of the output optical coupler 10, 10′ of each Mach-Zehnder interferometer 6, 8 is arranged in cross configuration with respect to the one and only one first port 13, 13′ of the input optical coupler 9, 9′ of the respective Mach-Zehnder interferometer (i.e. it belongs to a different optical branch). In one embodiment, not shown, the one and only one second port of the output optical coupler of each Mach-Zehnder interferometer is a bar port.

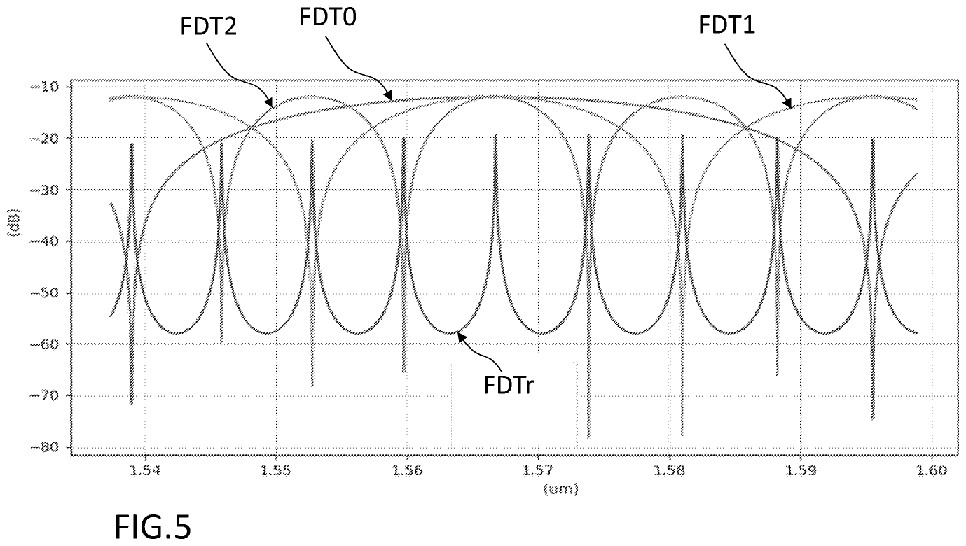

A difference in respective optical path dL₀ between the first 11 and second optical branch 12 of the first Mach-Zehnder interferometer 6, and exemplarily a respective difference in optical path dLᵢ between the first and second optical branch of each second Mach-Zehnder interferometer 8, are greater than zero and all different to each other. Exemplarily the difference in optical path dL₀ between the first and the second optical branch of the first Mach-Zehnder interferometer 6 is function of a band of the optical signal to be analyzed (for example from about 1520 nm to about 1580 nm). In more detail, the difference in optical path dL₀ is exemplarily such that a transfer function FDT0 of the first Mach-Zehnder interferometer 6 (FIG. 5) has respective free spectral range substantially equal to the width of the band of the optical signal (in the example about 60 nm).

FIG. 5 shows the trend of the transfer function FDT0 (expressed in dB) as the wavelength (expressed in um) varies. In FIG. 5, the free spectral range corresponds to the distance between two consecutive valleys of the transfer function FDT0.

Exemplarily the respective difference in optical path dLᵢ of each second Mach-Zehnder interferometer 8 is function of the difference in optical path of the first Mach-Zehnder interferometer 6. In particular, the difference in optical path dLᵢ of the i-th second Mach-Zehnder interferometer is exemplarily given by the formula dLᵢ=2ⁱdL₀, with i=1,2. Exemplarily therefore dL₁=dL₀ and dL₂=4dL₀.

FIG. 5 also shows the transfer functions of both the second Mach-Zehnder interferometers FDT1 (for i=1) and FDT2 (for i=2). It can be observed how the free spectral range of FDT1 (equal to the distance between two respective consecutive valleys) is halved with respect to the free spectral range of FDT0, and how the free spectral range of FDT2 is in turn half of the free spectral range of FDT1. In this way, within the band of the optical signal, one and only one wavelength value is obtained at which FDT0, FDT1 and FDT2 each have a respective coincident peak repetition (exemplarily this value corresponds to about 1567 nm). As shown in FIG. 5, the remaining repetitions of the peak of FDT1 are all at valleys of FDT0 and the remaining repetitions of the peak of FDT2 are all arranged at valleys of FDT0 or FDT1, thus obtaining a mutual suppression effect.

Exemplarily the differences in optical path of the Mach-Zehnder interferometers are all comprised between 1 μm and 2 mm, extremals included.

Exemplarily the first ring resonator 7 is the single ring resonator of the optical filter stage 2, and it exemplarily comprises a single micro-ring, an input port 15 and a drop port 16.

Exemplarily the first ring resonator 7 is optically connected to a respective remaining portion of the optical path 5 by means of only the input port 15 and by means of only the drop port 16.

Exemplarily the input port 3 of the optical filter stage 2 coincides with the one and only one first port 13 of the input optical coupler 9 of the first Mach-Zehnder interferometer 6, and the output port 4 of the optical filter stage 2 coincides with the drop port 16 of the first ring resonator 7.

Exemplarily a radius R of the micro-ring of the first ring resonator 7 is a function of the difference in optical path of the first Mach-Zehnder interferometer 6, more specifically, a circumference of the micro-ring of the first ring resonator 7 is exemplarily equal to 2ⁿ⁺¹ times the difference in optical path dL₀ of the first Mach-Zehnder interferometer, with n equal to two (i.e. the total number of second Mach-Zehnder interferometers 8). Exemplarily it is obtained 2πR=8dL₀.

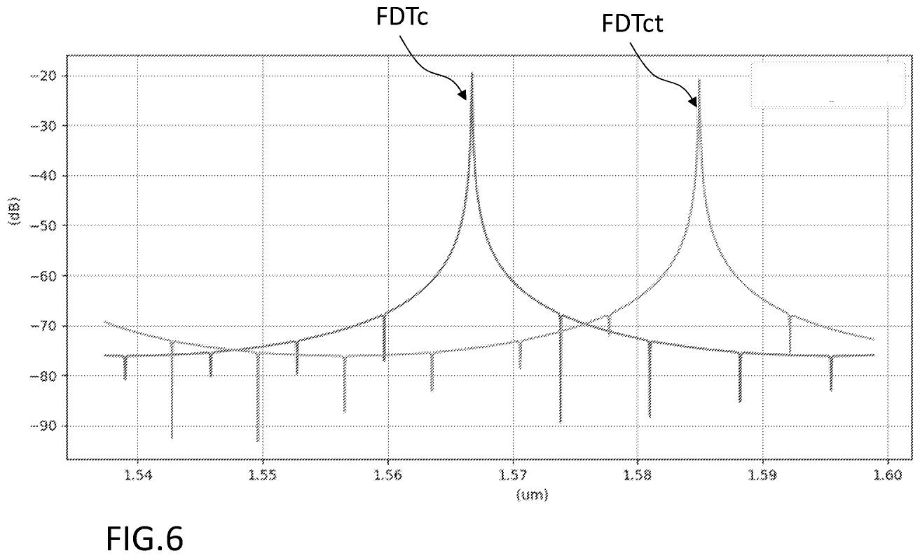

FIG. 5 shows the transfer function of the first ring resonator FDTr: it is characterized by a peak of reduced amplitude with frequent repetitions within the band of the optical signal. It is observed that all the repetitions of the FDTr peak, except the one at 1567 nm, are arranged at a valley of FDT0 or FDT1 or FDT2, thus resulting nullified. This is achieved in simple way thanks to the aforementioned relationship between the radius R of the micro-ring and dL₀. In this way it is exemplarily possible to obtain the overall transfer function FDTc of the optical filter stage shown in FIG. 6 (obtained by the product of FTD0, FDT1, FDT2 and FDTr). It can be observed how the FDTc has, thanks to the first ring resonator, a desired resolution (corresponding to the amplitude of the respective peak at 1567 nm), and, thanks to the first MZI, desired free spectral range, since only one peak repetition is present within the band of the optical signal of interest.

In one embodiment (not shown) the optical filter stage can comprise one or more second ring resonators (distinct from the first ring resonator) connected to each other in cascade, preferably in continuous succession with the first ring resonator, to each form a respective portion of said optical path. Preferably the radius of the respective micro-ring of the first ring resonator and the respective radius of the micro-ring of each second ring resonator are all different to each other.

Preferably a respective circumference of a micro-ring of each second ring resonator is equal to 2^{n+1+m} times the difference in optical path of the first Mach-Zehnder interferometer, with m equal to the (progressively increasing) order of the second resonator ring.

The device 1 comprises a photodetector 17, optically connected to the optical filter stage 2 downstream of the output port 4 (the photodetector 17 is exemplarily optically connected directly downstream of the drop port 16).

The device 1 comprises an actuator 18, coupled to the optical filter stage 2 and configured to vary an optical refractive index of at least one section of the optical path 5 of the optical filter stage.

For example, the actuator can exploit the thermo-optical effect, or the electro-optical effect, or both. In one embodiment, the actuator can be structured to vary the optical refractive index at one (or both) of the branches of one or more of the MZIs or of the ring resonator, for example as known. In one embodiment, the actuator can be structured to directly vary the optical refractive index of one or more of the MZIs directly at level of one or both of the respective optical couplers, as for example described in patent applications no. 102021000025160 and no. 102021000025166 in the name of the same Applicant.

Exemplarily the device 1 comprises a pre-treatment stage 19 of the optical signal upstream of the optical filter stage. Exemplarily the pre-treatment stage 19 comprises a polarization separator 20 for separating a first polarization component TE (e.g. a transverse electric polarization component) from a second polarization component TM (e.g. transverse magnetic) of the optical signal.

Exemplarily the pre-treatment stage 19 comprises a respective input port 21 and a respective first 22 and a respective second output port 23 (respectively for the first and second polarization component).

Exemplarily the pre-treatment stage 19 further comprises a polarization rotator 24 for rotating a polarization of the second polarization component TM of the optical signal (e.g. by 90°).

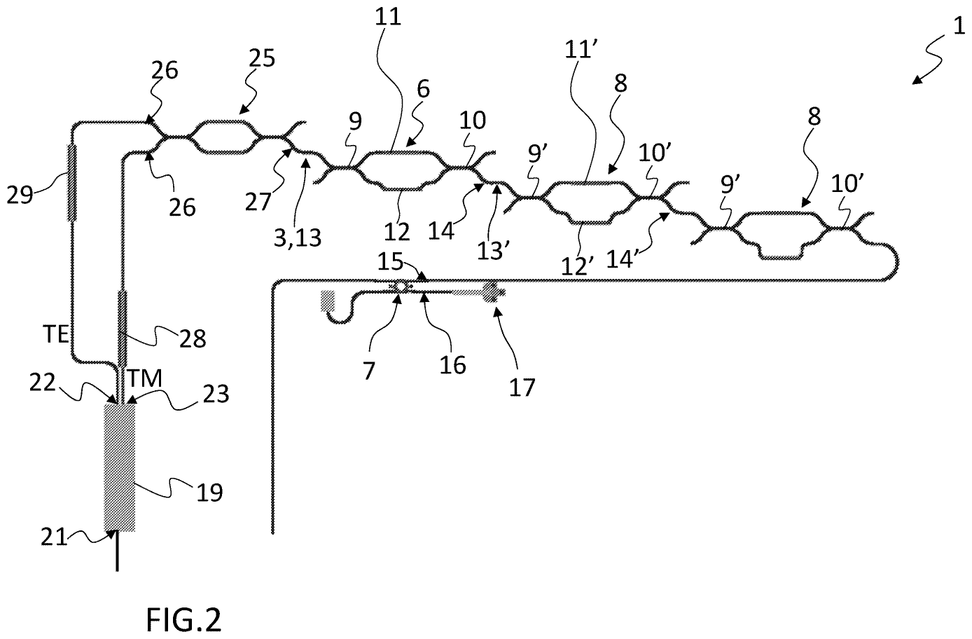

In a first embodiment (FIGS. 1 and 2) the device 1 comprises a further optical coupler 25 (distinct from the Mach-Zehnder interferometers) interposed between the pre-treatment stage 19 and the optical filter stage 2.

Exemplarily the first 22 and the second output port 23 of the pre-treatment stage 19 are directly optically connected respectively to one and only one respective first port 26 of the further optical coupler 25, and one and only one second port 27 of the further optical coupler 25 is directly optically connected to the input port 3 of the optical filter stage 2, in more detail directly optically connected to one and only one first port 13 of the input optical coupler 9 of the first Mach-Zehnder interferometer 6.

Exemplarily the further optical coupler 25 is a tunable balanced Mach-Zehnder interferometer with a splitting ratio variable from 0-100.

Exemplarily the device 1 further comprises a first 28 and a second optical switch 29 (e.g. a variable optical attenuator or VOA) respectively interposed between the respective first 22 and second output port 23 of the pre-treatment stage and the corresponding first port 26 of the further optical coupler 25.

Exemplarily the continuous succession of Mach-Zehnder interferometers is arranged directly upstream of the first ring resonator 7, the input port of the first ring resonator being directly optically connected to one and only one output port 14′ of the output optical coupler 10′ of the second Mach-Zehnder interferometer 8 arranged in last position.

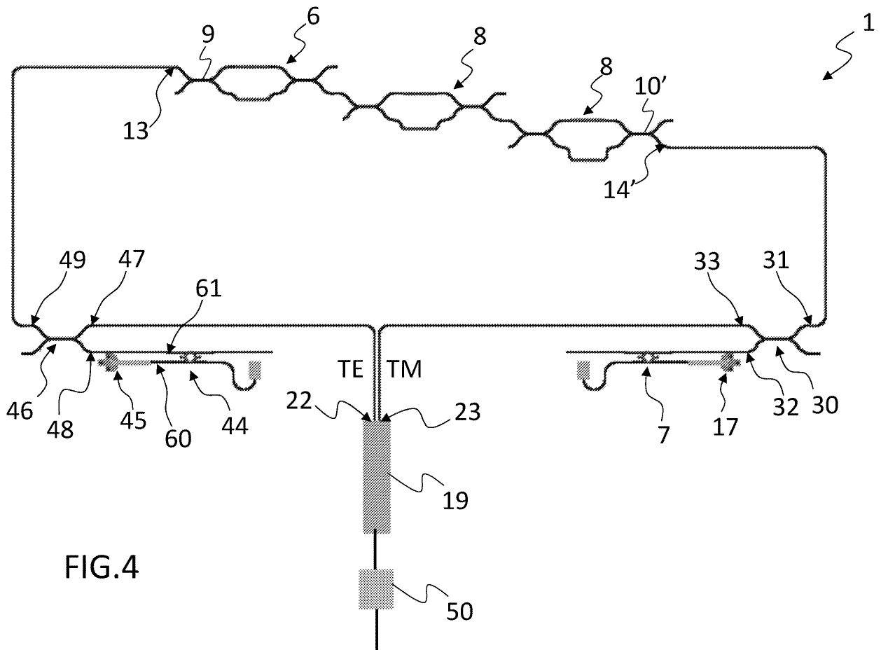

In a second embodiment (FIGS. 3 and 4) the optical filter stage 2 comprises a first 3 dB optical coupler 30 (distinct from the Mach-Zehnder interferometers) to form a respective portion of the optical path 5 and interposed between the second Mach-Zehnder interferometer 8 arranged in last position and the first ring resonator 7.

Exemplarily one and only one first port 31 of the first 3 dB optical coupler 30 is directly optically connected to the one and only one second port 14′ of the output optical coupler 10′ of the second Mach-Zehnder interferometer 8 arranged in last position, one and only one second port 32 of the first 3 dB optical coupler 30 is directly optically connected to the input port 15 of the first ring resonator 7 and a remaining second port 33 of the first 3 dB optical coupler 30 is directly optically connected to the second output port 23 of the pre-treatment stage 19.

Exemplarily the device 1 comprises a further optical filter stage 40 (limited by the closed dash-double point line) comprising a further input port 41, a further output port 42 and a further optical path 43 which develops from the further input port to the further output port.

Exemplarily the further optical filter stage 40 comprises the first Mach-Zehnder interferometer 6 and both the second Mach-Zehnder interferometers 8 in common with the optical filter stage 2, and a further ring resonator 44 (distinct from the first resonator ring 7) connected to each other in cascade to form respective portions of the further optical path 43.

Exemplarily the further ring resonator 44 comprises all the features of the first ring resonator 7, where appropriate referred to the further optical filter stage 40.

Exemplarily the device 1 comprises a further photodetector 45 optically connected to a drop port 60 of the further ring resonator 44.

Exemplarily the further optical filter stage 40 comprises a second 3 dB optical coupler 46 (distinct from the Mach-Zehnder interferometers and from the first 3 dB optical coupler 30) to form a respective portion of the further optical path and interposed between the first Mach-Zehnder interferometer 6 and the further ring resonator 44.

Exemplarily one and only one first port 47 of the second 3 dB optical coupler 46 is directly optically connected to the first output port 22 of the pre-treatment stage 19, a remaining first port 48 of the second 3 dB optical coupler 46 is directly optically connected to an input port 61 of the further ring resonator 44, and one and only one second port 49 of the second 3 dB optical coupler is directly optically connected to the one and only one first port 13 of the input optical coupler 9 of the first Mach-Zender interferometer 6.

Exemplarily the radius of the micro-ring of the first ring resonator 7 and of the further ring resonator is less than or equal to 500 μm.

In the second embodiment, the device 1 exemplarily comprises an optical isolator 50 arranged upstream of the pre-treatment stage 19.

In one embodiment (not shown), the further optical filter stage may comprise a plurality of further ring resonators (similarly to the second ring resonators of the optical filter stage).

Exemplarily the actuator 18 is also coupled to the further optical filter stage 40 and configured to vary an optical refractive index of at least one section of the further optical path of the further optical filter stage.

Exemplarily (not shown) the actuator comprises a respective sub-actuator for each Mach-Zehnder interferometer and for each ring resonator (to vary an optical refractive index of a tract of a respective optical path). Exemplarily each sub-actuator can be of known type (e.g. electric heater, pair of electrodes electrically connected to the optical waveguide, etc.).

Exemplarily the device comprises semiconductor optical waveguides to connect the various optical components described above. Exemplarily the device can be made on any semiconductor photonics platform such as for example silicon, silicon on insulator, silicon nitride, indium phosphide, silicon carbide, gallium arsenide, lithium niobate or any other semiconductor waveguide platform.

In use, the device 1 allows to perform a method for analysis of optical spectrum of an optical signal having a band. The method comprises introducing the optical signal as input to the device. The optical signal is exemplarily filtered by the optical filter stage 2 (and possibly by the further optical filter stage 40) and only a portion of the optical signal, corresponding to the passband of the filter, is allowed to transit towards the photodetector 17 (and possibly towards the further photodetector 45).

With reference to the aforementioned first embodiment of the device, the method exemplarily comprises actuating one of the two optical switches 28, 29 to make transit, towards the further optical coupler 25, only one polarization component at a time. The further optical coupler 25 is then consequently tuned to allow maximum bar or cross transfer depending on the input polarization component to be transmitted to the optical filter stage. For example, if it is desired to transmit the polarization component TE to the optical filter stage, it is provided activating the first switch 28 to preclude the transmission of the TM component and tuning the further optical coupler 25 in cross configuration (so that the TE component entirely passes through the further optical coupler). The opposite applies for the TM component. For example, it may be provided analyzing the optical intensity of the TE component only in the optical signal band and subsequently perform the same for the TM component.

With reference to the aforementioned second embodiment of the device, the method exemplarily comprises simultaneously analyzing both the polarization components TE and TM, which therefore simultaneously pass through the device, in particular the three MZIs, with opposite propagation directions. For example, the TE component, once it has passed the pre-treatment stage 19, reaches the second 3 dB optical coupler 46 and is (partially) transmitted to the optical filter stage through the second port 49. Conversely, the TM component, after having passed through the three MZIs, reaches the second 3 dB optical coupler 46 through the second port 49 and is (partially) transmitted to the further ring resonator 44 by means of the remaining first port 48. Specularly applies to the first 3 dB optical coupler 30.

The method therefore comprises tuning, by means of the actuator 18, the optical filter stage (and possibly the further optical filter stage) to move the passband of the optical filter stage (and possibly of the further optical filter stage) along the band of the optical signal (i.e. translating the FDTc of FIG. 6 along the horizontal axis of the wavelengths). FIG. 6 shows an example of shifted overall transfer function FDTct which corresponds to the FDTc of the optical filter stage shifted as a consequence of the tuning of the optical filter stage by means of the actuator 18. It can be seen how the passband of the optical filter stage has been exemplarily moved towards higher wavelength values.

The optical filter stage can for example be tuned by actuating one or more of the sub-actuators associated to the MZIs 6,8 and to the first ring resonator 7 (similarly for the further optical filter stage, with reference to the sub-actuators of the MZIs 6,8 and to the sub-actuator of the further ring resonator 44). Exemplarily the method may comprise a phase of preliminary calibration of the operating points of the sub-actuators (e.g. by means of known calibration methods which will therefore not be further described in detail).

The method therefore comprises, for each passband, acquiring by means of the photodetector (and possibly also by means of the further photodetector) a respective signal representative of an optical intensity of the optical signal in the passband.

Finally, the method comprises calculating the optical spectrum of the optical signal as a function of the aforementioned respective signals representative of the optical intensity.

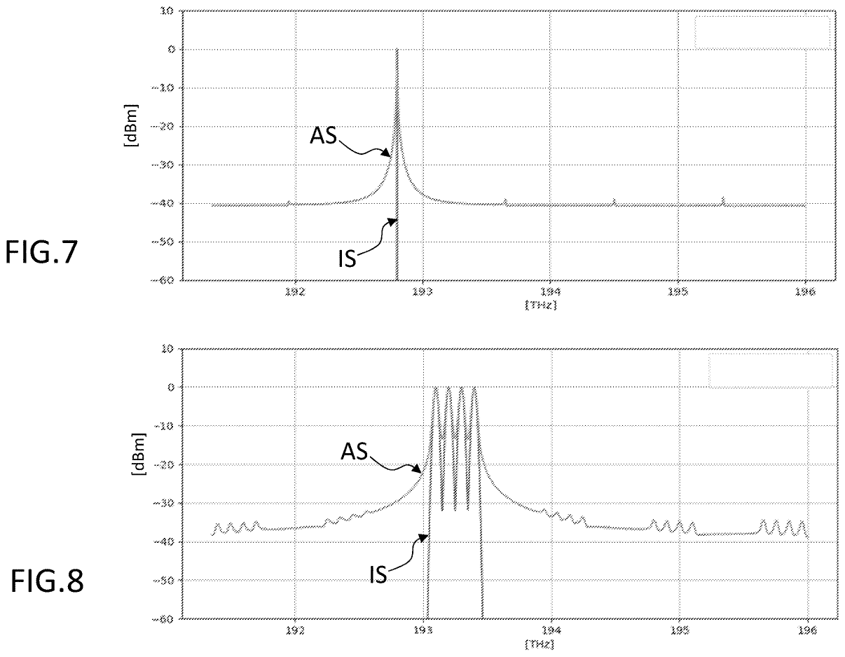

FIGS. 7 and 8 show the results of some simulations of the method according to the present invention (shown with reference to the component TE only, regardless of the embodiment of the device). The vertical axis shows the optical intensity in dBm, while the horizontal axis shows the frequency in THz.

In FIG. 7 the optical input signal IS is simulated as a Dirac delta, while the remaining curve represents the acquired signal AS (i.e. the set of all the respective signals representative of the optical intensity of the passband).

In FIG. 8 the optical input signal IS is simulated as a wave of variable wavelength intensity, characterized by four consecutive distinct peaks and which is zeroed outside a respective band. The remaining curve is the respective acquired signal AS.

It can be observed that in the examples of FIGS. 7 and 8, each respective acquired signal AS represents the convolution between the optical spectrum of the input optical signal IS and the overall transfer function of the optical filter stage FDTc.

In order to further improve the resolution of each acquired signal AS, the method exemplarily comprises performing a deconvolution routine of the acquired signal AS. This algorithm exemplarily comprises the following steps:
calculating the Fourier transform of the overall transfer function FDTc of the optical filter stage;
calculate the Fourier transform of the acquired signal AS (i.e. of the respective signals representative of the optical intensity in the band of the optical signal);
for each passband, calculating a quotient between the Fourier transform of the acquired signal AS and the Fourier transform of the overall transfer function;
calculating the anti-Fourier transform of the quotient.

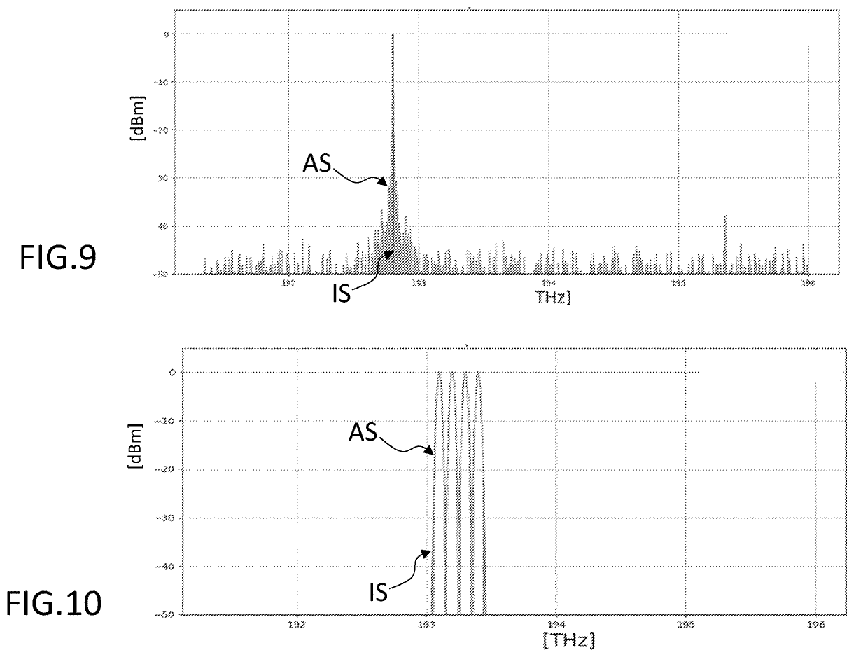

FIGS. 9 and 10 show the result of the aforementioned deconvolution routine applied to the acquired signal AS of FIGS. 7 and 8, together with the corresponding optical input signal IS (in FIG. 9 shown as a dotted segment). The vertical axis shows the optical intensity expressed in dBm, while the horizontal axis shows the frequency expressed in THz.

It can be observed how the resolution of the acquired signals is improved with respect to the corresponding signal before the application of the aforementioned algorithm.

In FIG. 9 the peak of the acquired signal has narrowed almost to coincide with the input optical signal, while in FIG. 10 the acquired signal substantially exactly follows the input optical signal.

In particular, the Applicant has observed that, in the shown examples, the resolution thanks to the above deconvolution routine has gone from about 10 GHz (FIGS. 7 and 8) to about 4 GHz (FIGS. 9 and 10). What has been described above with reference to the method and the deconvolution routine also analogously applies to the further optical filter stage.

1. A device for analysis of optical spectrum of an optical signal, said device comprising:
an optical filter stage having an input port an output port and an optical path which develops from said input port to said output port;
a photodetector, optically connected to said optical filter stage downstream of said output port;
an actuator, coupled to said optical filter stage and configured to vary an optical refractive index of at least one section of said optical path of said optical filter stage;
wherein said optical filter stage comprises a first Mach-Zehnder interferometer and a first ring resonator connected to each other in cascade to form respective portions of said optical path
wherein said first Mach-Zehnder interferometer comprises an input optical coupler, an output optical coupler and a first and a second optical branch which connect said input optical coupler to said output optical coupler
wherein a difference in respective optical path (dL₀) between said first and second optical branch of said first Mach-Zehnder interferometer greater than zero,
and wherein said first Mach-Zehnder interferometer is optically connected to a remaining portion of said optical path of the optical filter stage means of one and only one first port of the input optical coupler and by means of one and only one second port of the output optical coupler.

2. The device according to claim 1, wherein said optical filter stage comprises one or more second Mach-Zehnder interferometers connected to each other in cascade to each form a respective portion of said optical path, wherein each second Mach-Zehnder interferometer comprises a respective input optical coupler, a respective output optical coupler and a respective first and second optical branch which connect said respective input optical coupler to said respective output optical coupler, wherein a difference in respective optical path (dLᵢ) between said respective first and second optical branch is greater than zero, wherein said differences in respective optical path of said first Mach-Zehnder interferometer and of said one or more second Mach-Zehnder interferometers are all different from each other, wherein each second Mach-Zehnder interferometer is optically connected to a respective remaining portion of said optical path of the optical filter stage by means of one and only one respective first port of the respective input optical coupler and by means of one and only one respective second port of the respective output optical coupler and wherein said one or more second Mach-Zehnder interferometers comprise two, and no more than nineteen, second Mach-Zehnder interferometers.

3. The device according to claim 1, wherein said one and only second port of the output optical coupler of each Mach-Zehnder interferometer is arranged in cross configuration with respect to said one and only one first port of the input optical coupler of the respective Mach-Zehnder interferometer, wherein said first ring resonator is a single ring resonator of said optical filter stage, and wherein said actuator comprises a plurality of sub-actuators, each sub-actuator being coupled to a respective Mach-Zehnder interferometer or to a respective ring resonator.

4. Device according to claim 1, wherein said difference in optical path (dL₀) between said first and second optical branch of said first Mach-Zehnder interferometer is function of a band of the optical signal, wherein said difference in optical path (dL₀) is such that a transfer function (FDT0) of said first Mach-Zehnder interferometer has a free spectral range substantially equal to, or greater than, a width of said band of the optical signal.

5. The device according to claim 2, wherein said respective difference in optical path (dLᵢ) of each second Mach-Zehnder interferometer is function of the difference in optical path (dL₀) of said first Mach-Zehnder interferometer and is equal to 2 times said difference in optical path (dL₀) of the first Mach-Zehnder interferometer, with i equal to an order of the respective second Mach-Zehnder interferometer, wherein said difference in optical path (dL₀) of the first Mach-Zehnder interferometer is greater than or equal to 1 μm, wherein said difference in optical path of the first Mach-Zehnder interferometer, and said respective difference in optical path (dLᵢ) of each second Mach-Zehnder interferometer is less than or equal to 2 mm, wherein a radius (R) of a micro-ring of said first ring resonator is function of said difference in optical path (dL₀) of the first Mach-Zehnder interferometer, and wherein a circumference of the micro-ring of the first ring resonator is equal to 2ⁿ⁺¹ times said difference in optical path (dL₀) of the first Mach-Zehnder interferometer, with n equal to a total number of second Mach-Zehnder interferometers (8).

6. The device according to claim 1, comprising a pre-treatment stage of said optical signal upstream of said optical filter stage, wherein said pre-treatment stage comprises a polarization separator for separating a first polarization component (TE) from a second polarization component (TM) of the optical signal, wherein said pre-treatment stage comprises a respective input port and a respective first and a respective second output port, and wherein said pre-treatment stage comprises a polarization rotator for rotating a polarization of said second polarization component (TM) of the optical signal.

7. The device according to claim 6, comprising a further optical coupler interposed between said pre-treatment stage and said optical filter stage, wherein each of said first and second output port of the pre-treatment stage is optically connected to a respective first port of said further optical coupler, wherein one and only one second port (27) of said further optical coupler is optically connected to said input port of the optical filter stage, and wherein said device further comprises a first and a second optical switch respectively interposed between said respective first and second output port of the pre-treatment stage and the corresponding first port of the further optical coupler.

8. The device according to claim 6, wherein said optical filter stage comprises a first 3 dB optical coupler to form a respective portion of said optical path and interposed between said first Mach-Zehnder interferometer and said first ring resonator, wherein one and only one first port of said first 3 dB optical coupler is optically connected to said one and only second port of said output optical coupler of said first Mach-Zehnder interferometer, wherein one and only one second port of the first 3 dB optical coupler is optically connected to an input port of the first ring resonator, and wherein a remaining second port of the first 3 dB optical coupler is optically connected to said second output port of said pre-treatment stage.

9. The device according to claim 8, comprising a further optical filter stage comprising a further input port, a further output port and a further optical path which develops from said further input port to said further output port, wherein said further optical filter stage comprises said first Mach-Zehnder interferometer in common with the optical filter stage and a further ring resonator connected to each other in cascade to form respective portions of said further optical path, wherein said device comprises a further photodetector optically connected to said further optical filter stage downstream of said further output port, wherein said further optical filter stage comprises a second 3 dB optical coupler to form a respective portion of said further optical path and interposed between said first Mach-Zehnder interferometer and said further ring resonator, wherein one and only one first port of the second 3 dB optical coupler is optically connected to said first output port of said pre-treatment stage, wherein a remaining first port of the second 3 dB optical coupler is optically connected to an input port (61) of said further ring resonator wherein one and only one second port of the second 3 dB optical coupler is optically connected to said one and only one first port of said input optical coupler of said first Mach-Zehnder interferometer, wherein said device comprises an optical isolator arranged upstream of said pre-treatment stage, and wherein said actuator is also coupled to said further optical filter stage and configured to vary an optical refractive index of at least one section of said further optical path of said further optical filter stage.

10. A method for analysis of optical spectrum of an optical signal having a band, the method comprising:
providing a device for analysis according to claim 1;
introducing said optical signal as input to said device;
tuning, by means of said actuator, said optical filter stage to move a passband of said optical filter stage along said band of the optical signal;
for each passband, acquiring by said photodetector a respective signal representative of an optical intensity of said optical signal in said passband;
calculating said optical spectrum as a function of said respective signals representative of the optical intensity.

11. The method according to claim 10, further comprising a deconvolution routine of said signals representative of the optical intensity, wherein said deconvolution routine comprises:
determining an overall transfer function (FDTc) of said optical filter stage;
calculating a Fourier transform of said overall transfer function of the optical filter stage;
calculating a Fourier transform of said respective signals representative of the optical intensity in said band;
for each passband, calculating a quotient between said Fourier transform of said respective signals representative of the optical intensity and said Fourier transform of said overall transfer function (FDTc) of the optical filter stage (2);
calculating an anti-Fourier transform of said quotient.
